(19) United States
(12) Patent Application Publication
(10) Pub. No.: US 2026/0338704 A1
(43) Pub. Date: Oct. 29, 2026

(54) COMPOUND TRACE DETECTION DEVICE

(71) Applicant: Aditi Bhaskar, Wilsonville, OR (US)

(72) Inventor: Aditi Bhaskar, Wilsonville, OR (US)

(21) Appl. No.: 19/735,931

(22) Filed: Jul. 9, 2026

Related U.S. Application Data
(63) Continuation-in-part of application No. 17/963,832, filed on Oct. 11, 2022, now Pat. No. 12,730,039.
(60) Provisional application No. 63/394,317, filed on Aug. 2, 2022.

(51) Int. Cl. G01N 21/94; G01N 1/18; G01N 1/38; G01N 1/40; G01N 21/88; G01N 21/93

(52) U.S. Cl. CPC G01N 21/94; G01N 1/18; G01N 1/4022; G01N 1/4044; G01N 21/8806; G01N 21/93; G01N 1/38; G01N 2001/4038; G01N 2021/8845; G01N 2201/0221; G01N 2201/0693

(57) ABSTRACT

A detection device includes a collector having one or more inlets to collect one or more sample, one or more electrolysis subsystems, each electrolysis subsystem including at least two electrodes positioned to contact at least one sample to apply electrolysis to prepare the at least one sample for spectrometry, one or more spectrometry subsystems, each spectrometry subsystem connected to the one or more electrolysis subsystems and including one or more emitters and one or more receivers, each receiver corresponding to an emitter, and a controller to activate the one or more emitters and receive at least one signal from the one or more receivers and to provide a measurement of one or more compounds in the sample, a communication port to transmit data to allow display of the measurement, and a power supply electrically connected to at least the electrodes, the emitters, the receivers, the controller, and the display.

### RELATED APPLICATIONS

This application is a continuation-in-part of U.S. patent application Ser. No. 17/963,832, filed Oct. 11, 2022, which in turn claims benefit of U.S. Provisional Patent Application No. 63/394,317, filed Aug. 2, 2022, both of which are incorporated herein by reference in their entirety.

### TECHNICAL FIELD

This disclosure relates to the detection of trace compounds using both electrolysis and spectrometry.

### BACKGROUND

Nitrogen is an element abundantly found on Earth. In many cases, methods for detecting nitrogen are not accessible or sufficient.

Nitrogen is an essential ingredient in promoting plants ‘growth and has been the main ingredient in fertilizers used in agriculture. However, runoff of excess DIN (Dissolved Inorganic Nitrogen), often from inorganic fertilizers, into water bodies causes algae blooms and becomes detrimental for sustaining marine life, which in turn affects other life forms and the Earth. Nitrogen in the form of nitrate and the ammonium-ion-complex form the majority, over 90 percent, of DIN pollution. Nitrogen is also an important element in both natural and synthetic fentanyl drugs. By measuring the nitrogen content in alcohol or other beverages, a person can check whether their beverage has been contaminated.

Identifying nitrogen and its compounds in soil currently has high costs and a large time investment. Many farmers, especially in developing countries, have neither the time nor resources to go through these processes. This results in over-application of synthetic fertilizer, which has a lower cost when compared to taking nitrogen measurements. Since most crops look the same whether with sufficient or surplus nutrients, farmers may repeatedly apply fertilizer even after a surplus exists to prevent a deficiency of nutrients in the soil.

Hydroponic farming also needs a means to track nitrogen and other elements in the water in which the plants reside. Aquariums and other aqueous systems also have this need.

There are currently test strips for occasional use, and more chemistry-based detection processes for large farms, etc. Common chemistry-based methods for detecting nitrogen compounds include potentiometry, voltammetry, amperometry, and spectrometry. Although there are many detection methods, most are only capable of producing accurate or relevant results in lab settings. Even the most viable methods often have drawbacks, like interference with chlorine or other natural compounds, when used in natural or organic settings.

### BRIEF DESCRIPTION OF THE DRAWINGS

FIG. 1 shows a perspective view of handheld chemical detection device.

FIG. 2 shows a perspective view of the interior of first side of a portable chemical detection device.

FIG. 3 shows a perspective view of a portable chemical detection device.

FIG. 4 shows a side view and exploded views of parts of an embodiment of a handheld chemical detection device.

FIG. 5 shows an embodiment of a method of testing a sample for trace amounts of one or more chemicals.

FIG. 6 shows a block diagram of an embodiment of a chemical detection device.

FIG. 7 shows an embodiment of a spectrometry module using a broadband optical source and a photodetector array.

FIG. 8 shows an embodiment of an electrode's cleaning element, such as an electrode having a wiper ring.

FIG. 9 shows an embodiment of a channel having internal structures for mixing.

FIG. 10 shows an intensity versus wavelength graph for a copper electrolyzed 2.57 molarity ammonium-hydroxide sample.

FIG. 11 shows a copper (II) nitrate graph, after copper-electrolysis of 1.0 M magnesium-nitrate.

FIG. 12 shows an intensity versus molarity graph demonstrating the relationship between absorbance and molarity.

### DETAILED DESCRIPTION

The embodiments provide a novel methodology incorporated into a low cost, handheld, pocket size device. The device can measure nitrogen concentration of a sample within a few minutes using methodology of single cell copper electrolysis and spectrometry of specific copper-nitrogen compounds. The embodiments include a handheld device made from readily available, low-cost materials. In addition, the device reports the results within a few minutes and can be interpreted by users without technical training.

Currently, no published research exists on nitrogen detection methods that utilize both electrolysis and spectrometry in succession, as in the embodiments. This demonstrates the unique nature of the embodiments. The embodiments also account for interference from other compounds, such as sulfate, in the sample by using baseline wavelengths and taking a relative detection intensity rather than something absolute.

Providing this capability in a handheld device allows the users to have the results in their hands almost instantaneously. Most other current methods involve sending samples to labs and taking days to process. Knowing the concentration of nitrogen in an environment allows the user to make fact-based decisions when applying dissolvable inorganic nitrogen to an area. This also reduces pollution in nearby aquatic environments and improves the ecosystem. The device reduces biofouling since the chemically processed samples are less than three milliliters in quantity, not harmful, and diluted.

Commercial and rural farmers would benefit from the deployment of the embodiments of a device for a nitrogen detection process since commercial farmers often utilize time-taking lab-analysis methods and rural farmers spend excess money on wasted fertilizer. By using the methodology embodiments in place of other DIN detection systems, users have an inexpensive means to detect nitrogen levels. Using a portable device, including handheld devices, or an integrated system connected to the user via IOT (Internet of Things) provides results almost instantaneously to a wider audience, and for less cost than past detection systems. Users could use the embodiments here in any local or home gardening situations, such as hydroponics, aquariums, golf courses, etc. Any avid home gardener will find interest in this DIY DIN detection system.

Another advantage of this method is its simplicity. Nitrogen, potassium, phosphorus, and sulfur may also be detected and measured using variations of the embodiments. Farmers, horticulturists, and aquarium managers can measure and manage multiple critical elements.

In addition, fentanyl contains nitrogen compounds as well. Fentanyl is often dropped into drink illicitly. The embodiments here could allow people, especially women who are often targeted, to detect fentanyl using a small sample and keep them safe when they drink unfamiliar or foreign concoctions, especially since fentanyl dissolves in alcohol. The FDA would find this device helpful when checking for fentanyl or other nitrogen-based drugs.

The device is applicable across a wide range of industries and environments that require nutrient or compound monitoring. These include wastewater treatment facilities operating under discharge permit requirements, municipal drinking water utilities monitoring for nitrate compliance under EPA and WHO regulatory limits, stormwater, groundwater, and agricultural runoff monitoring programs, aquaculture and commercial fisheries operations, brewery and winemaking fermentation monitoring, recreational water systems such as swimming pools, and food safety testing contexts including detection of nitrogen-bearing adulterants in beverages. The device is equally suitable for deployment in resource-limited settings, including developing-world agriculture and emergency field response following floods or industrial contamination events. No limitation to any particular application domain is intended.

The embodiment of a low-cost device evaluates traces of the nitrogen concentration of a soil or liquid sample for the non-technical user. As mentioned above, this embodiment is also handheld, and reports data collected in readings almost instantaneously. This embodiment is comprised of widely available materials, improving the accessibility of the device. Anyone with the materials could construct this embodiment on their own, given instructions. This embodiment can be easily manufactured without very specifically engineered materials, which many other chemical-based methods require.

In some embodiments, the device may adaptively manage power consumption based on operational context. The controller may reduce measurement frequency, defer or batch wireless transmission, or power down inactive subsystems during periods of low activity or when battery power levels fall below a threshold. Notably, a device can also be powered from an external power source. Power management parameters may comprise a pre-set configuration prior to deployment based on expected usage patterns or adjusted dynamically in response to real-time battery state. Such adaptive power management extends operational lifetime in remote or continuous-monitoring deployments.

The device could employ multiple wavelengths, each wavelength having an emitter/sensor pair operating at a wavelength to detect a particular analyte. The device could also employ a single emitter which is broadband across at least one wavelength measured, or a single photodetector sensor which can measure at least one of the wavelengths required for computation. Other wavelengths, in addition to or instead of those discussed here. This view shows a first side of the device, referred to here as the “top,” with the understanding that the discussion could just as easily referred to it as the bottom.

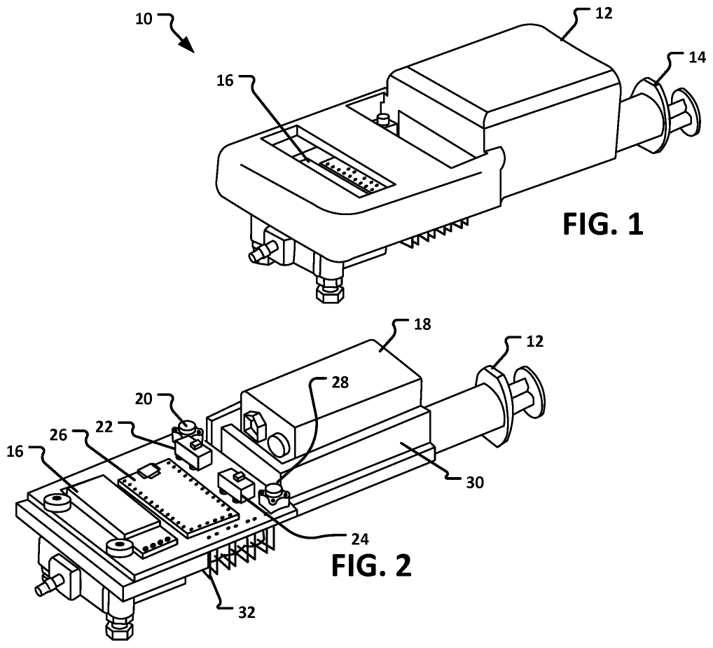

FIG. 1 shows a perspective view of an embodiment of a handheld chemical trace detection device 10. The device has a housing, cap, or electrical enclosure 12 that encloses the device components, a collector 14 that allows a user to collect a sample, and a display 16 to display the result. In one embodiment, collector 14 takes the form of a syringe with a plunger that allows the user to draw in the sample. As will be discussed below, the device may employ other means of sample collection.

FIG. 2 shows a perspective view of a first side of an embodiment of a handheld chemical trace detection device with the housing removed. The device has a power supply, in this embodiment in the form of a battery, and a battery holder 30. This may comprise plastic such as ABS (acrylonitrile butadiene styrene), or PDMS (polydimethylsiloxane), possibly 3D printed. The electrical enclosure keeps the electronics safe from fluids in the fluid housing, discussed in more detail further. The power supply may comprise an alternating current (AC) current source, or a direct current (DC) source.

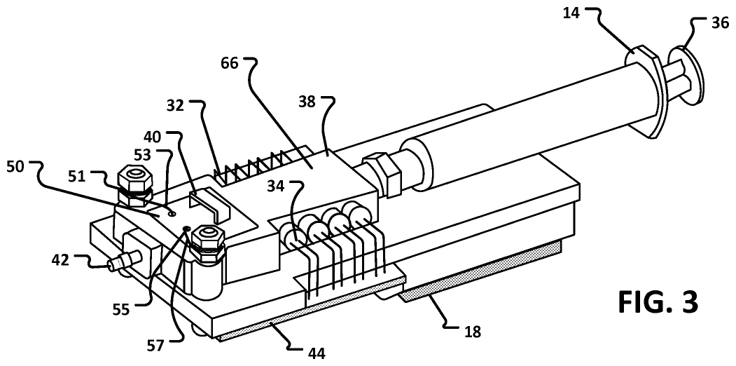

The device may operate by many different types of selectors. The embodiments here use push buttons and slider switches, but no limitation exist to those particular implementations. Push buttons 20 and 28 allow the user to pause, using one of the buttons, or cancel the processing sequences of the device. Similarly, two slider switches 22 and 24. One slider turns the overall device on, connecting the controller 26 to the power supply/battery 18. The other slider turns on and off the power to the electrodes in the electrolysis chamber, discussed in more detail later. The display 16 connects to the controller 26 and allows the user to see the results through an opening in the housing 12, as shown in FIG. 1. This view shows a small portion of the receivers, such as 32, but FIG. 3 shows these in better view.

FIG. 3 shows the other side, or “bottom” of the device. The collector 14 and plunger 36, in this embodiment, draw the sample in through a collector port 42. This may comprise a piece of tubing, such as barb tubing, that connects to the inlet into the electrolysis chamber. As the fluid enters the device, it first undergoes electrolysis in an electrolysis subsystem 50. Electrolysis chemically decomposes the sample by passage of an electric current through the sample.

For the embodiments here, the sample undergoes single cell copper electrolysis. For example, electrolysis makes all nitrates and ammonium compounds uniform. In the embodiments here, these compounds comprise either copper (II) nitrate or copper-ammonium-ion-complex by the end of the electrolysis. Copper comprises the excess reactant in the redox (reduction oxidation) reaction even for the most concentrated lab-grade samples of nitrogen compounds. The electrolysis allows for a detection of a single type of compound instead of detecting each compound separately. A similar process occurs for sulfate, phosphate, and other chemical species of interest.

Secondly, single cell copper electrolysis creates compounds of ammonium and nitrate in, or near the visible spectrum. Transmitters are easier to source, and at lower cost, when they are near the visible or IR ranges. Using different metals for the electrodes may have beneficial effects on the uniformity and visibility of other compounds.

The electrodes may be fabricated from any suitable low-reactivity conductive material, including but not limited to copper, silver, gold, platinum, and alloys thereof. The choice of electrode material may be selected based on the target compound, desired reaction uniformity, cost, or operational lifetime. The term “low-reactivity” as used here means a material that has a minimal amount of reactance such that no electrical or magnetic fields form when current flows through these materials. These materials include, but are not limited to, copper, silver, gold, platinum, or alloys thereof.

The electrodes will more likely require replacement after each use. As such, the electrode insert 40 allows the user to remove and replace the electrodes and the filters without tools, discussed in more detail later, for the electrolysis chamber between uses. The sample will exit electrolysis subsystem 50 and moves into the spectrometry subsystem 66. The spectrometry subsystem 66 includes emitters 34, each emitter having a corresponding receiver 32. These communicate with the controller 26 shown in FIG. 2, through the printed circuit board (PCB) 44, powered by the battery 18. The fluid housing 38 keeps the fluids in the fluid path separate from the electrical subsystem. The sample can exit the spectrometry subsystem, out of the device or for subsequent sample processing and/or measurements.

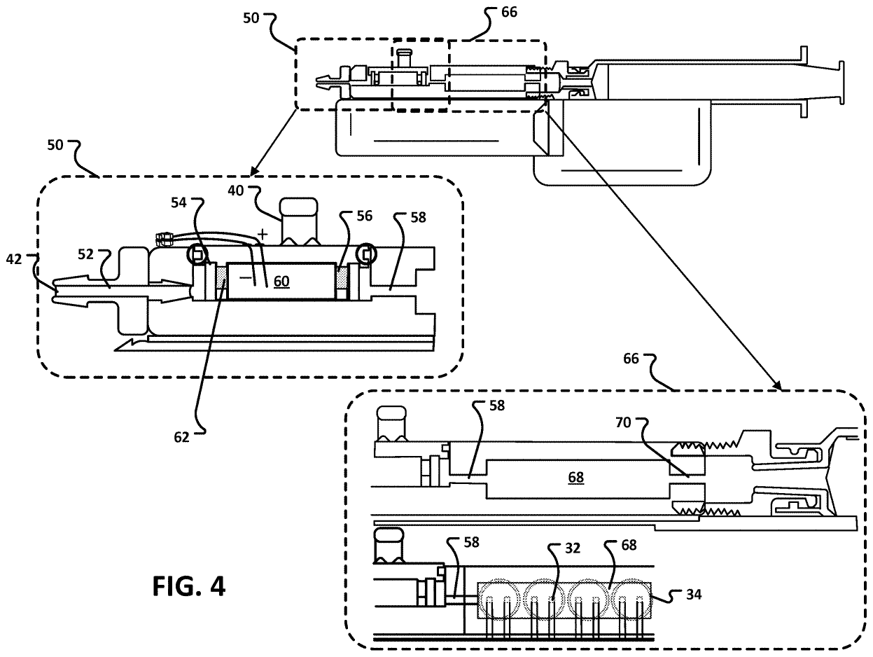

The bolts 51 and 55 conduct electricity from the battery under control of the microcontroller through the electrode wires 53 and 57, respectively. The wires 53 and 57 act as the electrodes. The microcontroller will pass the electricity into the electrode wires that cause the electrolysis process to occur. FIG. 4 shows a side view of the device and exploded views of the electrolysis subsystem 50 and the spectrometry subsystem 66. The exploded view 50 of the electrolysis subsystem shows the collector port 42 and the inlet 52 through which the sample enters the electrolysis subsystem. The sample solution will mix by way of one or more specially designed, turbid, microfluidic channels 58. Mixing the sample increases the uniformity before filtration. An inlet filter 54 provides filtering of the sample. One issue that may arise is the management of colloids in the sample. Colloids generally comprise insoluble particles dispersed throughout the fluid of the sample. These may interfere with the flow of the fluid of the sample through the system and may have a detrimental effect on the accuracy of the readings. The inlet filter 54 addresses this issue.

The sample then enters chamber 60 where it undergoes electrolysis. An outlet filter 56 then filters the sample as it moves into the fluid channel 58. As mentioned above, the inlet filter, outlet filter and electrodes may connect to an electrode insert 40, easily removable and replaceable between samples. The fluid channel 58 may have ridges or other features that increase the mixing of the sample.

The spectrometry subsystem 66 connects to the fluid channel 58 that passes the sample into the spectrometry chamber 68. The view of FIG. 4 shows the chamber alone at the top of the exploded view, and then with the emitters such as 34 and receivers such as 32 one either side of the chamber 68. Using energy from the power supply, the emitters illuminate the electrolyzed sample, and the receivers detect the light. The emitters may have a light guide, such as a narrow opening, lens, or window, to guide the illumination towards the receivers.

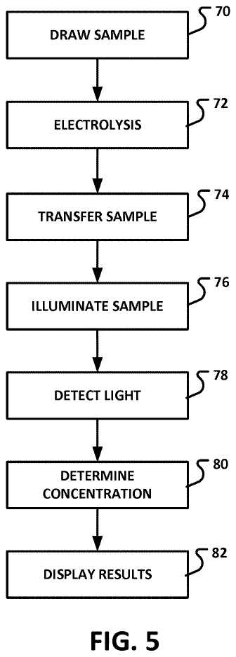

FIG. 5 shows a flowchart of an overall embodiment of a method of using the device to test samples for trace chemicals. The process starts at 70 where the user or device draws the sample into the device. The drawing of the sample may include a user pulling the plunger on a syringe or automated approaches where the device draws in the sample using a power source rather than by manual actuation via user action. Some embodiments may include a pump to move the sample into the collection chamber.

The sample undergoes electrolysis at 72. The user then transfers the sample to the spectrometry chamber at 74. The emitters then illuminate the sample 76 and the receivers detect the received light at 78. The controller then uses the information on the detected light to determine the concentration of the targeted compounds at 80. The controller may also make use of additional sensor readings, such as temperature and pH, past measurement data, and manually inputted data, such as geolocation and target crops, to determine the final concentration of the targeted compounds. The device then displays the results at 82. The results could include, but are not limited to, precise concentration measurements, range-based concentration measurements indicating ecosystem health, comparisons of concentration over timescale, comparisons with other currently and previously deployed sensors. These results can also be used to send signals out, i.e., sending a message when nutrient health is significantly above or below a threshold. Other sensor measurements such as pH, temperature, depth, GPS, turbidity, etc. may also be communicated over the display.

The results may be transmitted wirelessly or transferred to another device such as a mobile phone or workstation in addition to, or instead of, being displayed on the device's inbuilt display. The display may not be a physical part of the device but may instead be a remote display. The display may represent a communication port that allows the controller to transmit the data for display. The display may communicate results, device status, or any other information using any language or symbolic representation.

The device of FIGS. 1-4 comprise an example of a hand-held form factor. Other embodiments discussed below will include all the elements above and additional components.

These components may also be in the embodiments of FIGS. 1-4. The variations and embodiments exist in any of the various form factors discussed herein.

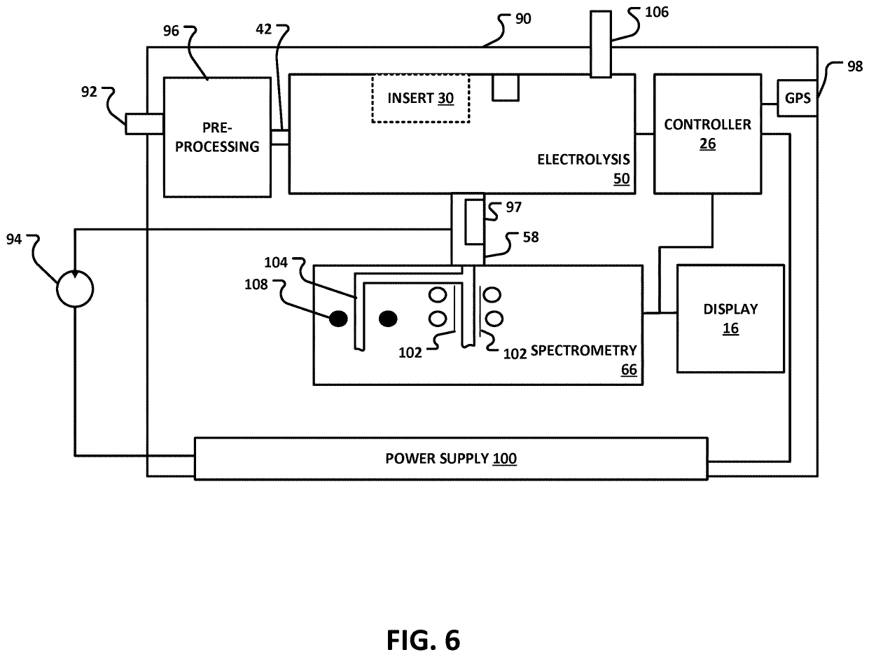

FIG. 6 shows an embodiment of a detection device 90. This device could be a bench-top device, integrated into an infrastructure, such as being mounted to take samples from pipes or ground water, mounted on a vehicle, or implemented in any other form factor appropriate to its application. This embodiment shows additional components and features, some of which or all of which may be included in other form factors such as the handheld device discussed above. The same reference numbers are used for the same components between the two figures.

In some embodiments, the spectrometry subsystem may incorporate optical filters and diffraction gratings to improve spectral selectivity and measurement precision. Optical elements 102 which may comprise bandpass or interference filters may be placed in the optical path between each emitter and the sample, or between the sample and each receiver, narrows the detected wavelength range to the absorption band of interest, reducing cross-channel interference and improving signal-to-noise ratio.

As shown in FIG. 7, the spectrometry chamber may include a module to illuminate the analyte with broadband light or other optical source 10 and use a diffraction grating or other optical element 112 to disperse transmitted light across a photodetector array and enabling continuous spectral data acquisition across a range of wavelengths rather than at discrete points. This module may operate along the same fluid path as the emitter-receiver pairs, a separate path shown as 104 in FIG. 6, or may operate instead of the emitter-receiver pairs. This configuration supports post-processing correction for spectral overlap between compounds and may permit detection of additional analytes without hardware modification. No limitation to any particular filter type, grating geometry, or detector array architecture is intended.

In some embodiments, the device may incorporate active mixing or agitation mechanisms within the electrolysis chamber or fluid channel to improve dispersion of colloidal particles and increase sample uniformity prior to spectrometric analysis. For example, a first prototype used a pump such as 94 in FIG. 6, which draws solution through a thin pipe, which causes some excitation, agitation, and mixing. Such mechanisms may include, but are not limited to, the introduction of pressurized air or gas bubbles into the fluid path, ultrasonic agitation of the sample chamber, or mechanical vibration of the fluid housing. Active bubble dispersion, in particular, may be implemented by a small pump or valve under controller direction, introducing controlled bursts of air into the sample stream to disrupt colloidal aggregation. No limitation to any particular agitation method is intended, and any mechanism that increases the homogeneity of the electrolyzed sample prior to optical measurement is within the scope of the embodiments.

The device may further compensate for ambient light interference by optically sealing the spectrometry chamber and taking differential receiver readings comparing illuminated and dark states.

Anomalous transmittance spikes indicative of bubble passage through the spectrometry chamber may be detected and discarded by the controller. The controller may be configured to monitor behaviors, such as spikes, and sample with a frequency sufficient to detect and discard anomalous readings. No limitation to the noise compensation mechanisms enumerated here is intended

In some embodiments, the inlet filtration stage may incorporate one or more physical filtration membranes selected to remove particulate matter, suspended solids, and colloidal aggregates present in soil-derived or field-collected samples prior to electrolysis. Where a soil sample has been prepared by steeping and straining, residual fine particulates may remain in suspension and interfere with both electrolysis uniformity and downstream optical measurement. Filter 54 of FIG. 4 may comprise a set of filter membranes of selected pore size may be staged in series, with a coarser pre-filter capturing large particles and a finer membrane providing additional clarification before the sample enters the electrolysis chamber. Filter membrane material may be selected for chemical inertness with respect to the target analytes. The inlet filter assembly may be incorporated into the replaceable electrode insert so that filter media and electrodes are replaced together between samples. No limitation to any particular pore size, membrane material, or filter staging configuration is intended.

In some embodiments, there may be a preprocessing step or preprocessing chamber 96 shown in FIG. 6 before the inlet 42 to the electrolysis chamber. Preprocessing may introduce one or more chemical reagents, including reducing (i.e., via electrolysis), pH buffering agents, or oxidizing agents. These are selected to convert, mask, or stabilize target analytes to form better downstream detection. In one example, a reducing agent or upstream electrolysis step may convert nitrate to ammonium prior to the main electrolysis step. In another example, a reagent may convert metal analytes such as iron, manganese, hexavalent chromium, or arsenic to a detectable chromophoric complex. The preprocessing chamber may be implemented as a passive mixing zone, an active microfluidic mixing chamber, or alternative styles of preprocessing.

In some embodiments, there may also be a postprocessing step which processes samples prior to ejecting them from the device. These can clean samples to reduce pollutants returning to the environment or take additional measurements.

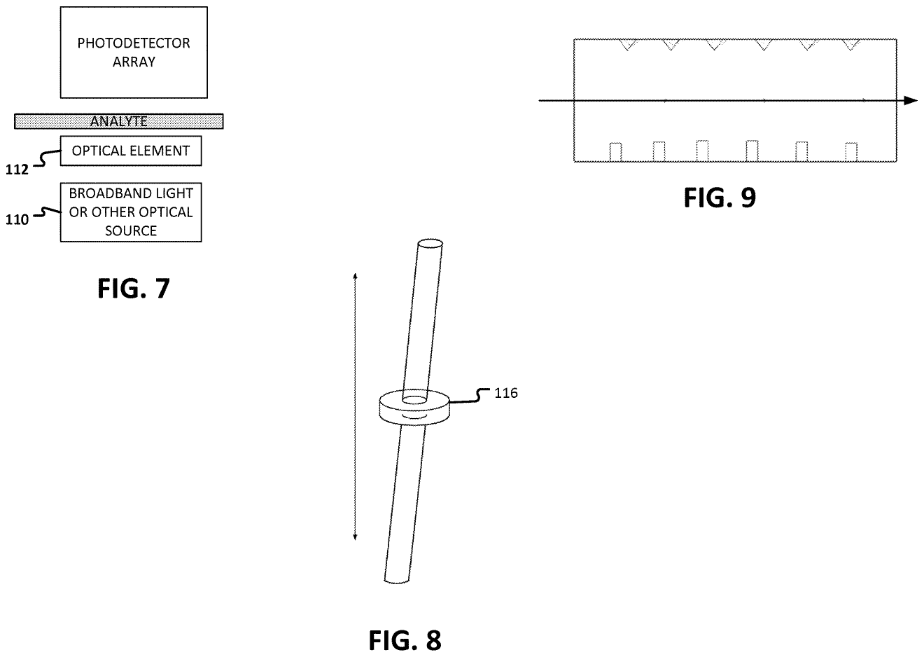

In some embodiments, the electrolysis chamber may incorporate a dedicated drain port 106, separate from the outlet leading to the conditioning channel and spectrometry subsystem. The drain port allows excess solution, precipitate-laden fluid, or rinse liquid introduced during a cleaning cycle to be expelled from the electrolysis chamber directly, without routing waste fluid through the conditioning channel or spectrometry subsystem. This architecture preserves the optical cleanliness of the spectrometry chamber during electrode maintenance and cleaning operations. Where a self-cleaning mechanism such as a wiper ring 116 shown in FIG. 8, or reverse-polarity conditioning pulse is employed, the drain port may be opened under controller direction prior to or during the cleaning cycle to flush dislodged precipitate and spent rinse fluid out of the electrolysis chamber before the next sample is introduced. A valve at the drain port, actuatable by the controller, may prevent unintended fluid loss during normal measurement operation while permitting controlled drainage during cleaning. No limitation to any particular drain geometry, valve type, or cleaning cycle integration is intended.

Channel 58 connecting the electrolysis chamber to the spectrometry chamber is a structurally distinct element that performs sample conditioning in transit. As shown in FIG. 9, Internal surface features including ridges or other features can induce passive mixing. Channel geometry provides a controlled residence time that allows transient reaction products to stabilize and dissolve gases to (partially) degas before optical measurement. The outlet filter of the electrolysis subsystem is positioned at the channel 58 inlet. This outlet filter may be cleanable and/or replaceable. This architecture (two physically separated chambers connected by an integrated conditioning channel) differs from configurations in which electrolysis and optical measurement occur within a single cell, and from configurations in which inter-chamber transfer relies on external pumping apparatus. However, we do not limit possible embodiments to have both electrolysis and spectrometry steps in distinct physical chambers.

The electrolysis subsystem and spectrometry subsystem may operate in a pipelined fashion to increase sample throughput. In microfluidic implementations, where the device 90 of FIG. 6 resides on a single microfluid chip, samples in a batch may be separated by controller-triggered introduction air bubbles between sample slugs, preventing cross-contamination between successive samples in the fluid path. Since each subsystem operates independently on a sample, a subsequent sample may enter the electrolysis subsystem while a prior sample is undergoing spectrometric analysis. This pipelining reduces total processing time when multiple samples from different sources must be evaluated in sequence. In one embodiment, multiple devices may be housed in a docking station that provides power, data aggregation, and coordinated display of results across all docked units, facilitating batch testing and device maintenance in laboratory or field station settings.

In some embodiments, a single sample may be split and routed through multiple electrolysis chambers simultaneously, with the resulting measurements averaged or compared across chambers to identify and reject outliers caused by electrode fouling, precipitate accumulation, colloidal interference, or electronics circuit issues. Disagreement between chambers beyond a configurable threshold may trigger an automatic cleaning cycle or flag the measurement for review. No limitation to any particular redundancy configuration is intended.

In some embodiments, a single spectrometry subsystem may be paired with multiple electrolysis chambers operating in parallel, such that successive samples complete electrolysis in staggered intervals and are queued for spectrometric analysis in sequence. For example, a device with three electrolysis chambers and one spectrometry chamber may initiate electrolysis in each chamber at offset intervals, maintaining a continuous pipeline of prepared samples ready for optical measurement and reducing idle time in the spectrometry subsystem. This could improve throughput while maintaining only a single spectrometry subsystem.

In some embodiments, a single electrolysis subsystem may be paired with multiple spectrometry chambers operating in parallel, such that the output of a single electrolysis cycle may be routed to independent optical subsystems simultaneously. This configuration may increase throughput when sample volume is small and electrolysis completes rapidly, since multiple spectral measurements may proceed concurrently rather than sequentially. Additionally, routing a single prepared sample to multiple spectrometry chambers may serve a cross-validation function, allowing measurements from independent optical paths to be compared and outliers caused by detector drift, lamp degradation, or optical path contamination to be identified and rejected. No limitation to any particular ratio of electrolysis chambers to spectrometry chambers is intended. FIG. 8 shows embodiments of these types of architectures.

As will be discussed in more detail later, the detection of the light allows the device to determine the molarity of the compounds associated with the wavelengths of the detectors. In one embodiment, three emitters in the device emit different wavelengths of light, including 520 nm as a baseline, 615 nm for the copper-ammonium-ion complex, and 850 nm for copper (II) nitrate. The measurements are converted to “relative data instead of absolute data to avoid colloidal interference. As discussed above, there is no limitation in the device to these particular compounds and other emitters may allow detection of other compounds. Similarly, the system may implement other forms of measurement including electromagnetic forces, a spinning chamber, or an electrostatic filter, as examples.

The spectrometry subsystem may include emitter and corresponding receivers operating at any wavelength accessible via the compound or compounds produced by the electrolysis preprocessing stage. The device is not limited to discrete wavelength values. Emitters and receivers may be selected across the visible and near-infrared spectrum as determined by the absorption characteristics of the electrode-compound complexes produced during electrolysis. In one embodiment, all emitters illuminate the sample simultaneously, with each receiver optically isolated to detect only its paired wavelength. In an alternative embodiment, emitters fire sequentially under controller direction, with receivers read in turn, based upon either a number of analytes or available hardware. Both simultaneous and sequential illumination modes are within the scope of the embodiments. The subsystem is not limited to the specific wavelengths described elsewhere in this disclosure; additional emitter-receiver pairs may be added to support detection of further compounds including phosphate (PO₄³⁻) and sulfate (SO₄²⁻). No limitation to the visible range alone is intended; embodiments operating in the near-infrared range, such as the 850 nm nitrate channel, are equally contemplated, and further pairs at other wavelengths within the accessible spectrum of electrode-compound complexes are within the scope of the disclosure.

In some embodiments, the device may detect dissolved nitrous oxide (N₂O), a potent greenhouse gas produced during biological nitrogen removal in wastewater treatment. Where electrolysis conditions produce N₂O-bearing complexes with accessible absorption wavelengths, additional emitter-receiver pairs operating at those wavelengths may be added to the spectrometry subsystem, with the controller processing the additional channel through the same calibration framework used for nitrate and ammonium. No limitation to any particular electrolysis condition or wavelength is intended.

Prior to use, the device should undergo calibration, typically prior to shipment to users, to associate the molarity to the intensity. Calibration involves taking readings of multiple samples at multiple known molarities. Plotting the molarities of the calibration samples against their absorbance intensities should give a linear fit, and the constant value, one for each compound or wavelength, for the slope can be hardcoded into the molarity calculations.

The device can derive a quantitative turbidity estimate by comparing transmittance at the baseline wavelength (which falls outside target compound absorption bands and therefore reflects primarily scattering losses) against transmittance at compound-detection wavelengths. This turbidity value may be reported as a standalone output, used to correct compound molarity calculations for scattering-induced error, or used to flag samples exceeding a reliability threshold. No limitation to any particular baseline wavelength or differential calculation method is intended. For purposes of this disclosure, the turbidity estimate derived by the controller is treated as a sensor measurement in the same manner as pH, temperature, or other environmental sensor inputs, and may be incorporated as one of the accumulated field measurements used by the calibration and/or prediction model.

In some embodiments, calibration may employ multivariate regression models that incorporate measurements across all active wavelength channels either simultaneously or in sequence. Active wavelength channels include cross-compound interaction terms to account for partial spectral overlap between compounds and the effects of sample turbidity. The controller may store and execute such models on-chip. In additional embodiments, the calibration model may be adaptive, updating its parameters based on accumulated measurement data over time. Calibration may also make use of variables from sensors or externally measured data, which is inputted manually or via an alternative connection, e.g., the internet or GPS location. Pre-trained models may be loaded prior to deployment, and the device may support on-device inference using lightweight machine learning architectures suited to embedded systems. No limitation to linear or single-variable regression is intended.

The calibration and/or prediction model is not limited to any particular modeling approach; suitable implementations include, without limitation, linear or multivariate regression, stochastic models, heuristic rule-based methods, or machine learning architectures such as neural networks. The model may be pre-trained prior to deployment, continuously updated through a feedback loop of accumulated field measurements, or both. No limitation to any particular model type, training methodology, or updating mechanism is intended.

In some embodiments, the calibration model may incorporate site-specific measurement history and agronomic context to improve measurement accuracy over time. Past measurements from a given deployment location may be used to build a location-specific and/or a location-adaptive baseline that is updateable with new data, accounting for soil matrix characteristics particular to that site. The controller may additionally accept user-provided feedback, such as crop cycle outcomes or observed plant health indicators, to flag potential systematic errors in the calibration model and trigger recalibration. In some embodiments, the device may receive external data from remote sensing sources, including drone imagery or satellite/satellite image-derived vegetation indices, to correlate optical indicators of plant nutrient status (such as leaf chlorosis associated with nitrogen deficiency or toxicity) with ground-level compound measurements. Such externally-derived signals may serve as inputs to the calibration model or as independent validation of device readings. No limitation to any particular feedback source or agronomic data integration method is intended.

The pH of the sample may affect the efficiency and uniformity of the electrolysis reaction. In some embodiments, the device can condition sample pH prior to electrolysis by one of two approaches: a buffering agent reservoir upstream of the electrolysis chamber such as in pre-processing chamber 96, delivers a metered quantity of buffer under controller direction, bringing the sample within a target pH range of approximately 6 to 8. A pH sensor that may be located in pre-processing unit 96, upstream of the electrolysis chamber provides a real-time measurement that the controller incorporates as a correction variable in the calibration model, compensating for pH-dependent absorbance variation without active adjustment. No limitation to any particular buffering agent or pH management approach is intended.

In some embodiments, real-time temperature measurement may be incorporated as an input to the calibration model. Because absorbance characteristics of electrode-compound complexes vary with sample temperature, a temperature sensor integrated into the fluid path or spectrometry chamber may provide a correction factor applied during molarity calculation. Temperature compensation may be implemented as a fixed lookup table derived from calibration data collected at multiple temperatures, or as a term within a multivariate regression or machine learning model. The device may also record sample temperature alongside compound concentration measurements as part of the output data log. In one embodiment, the electrolysis electrodes may serve a dual function, resistively heating the sample to a target temperature prior to measurement. Given sample volumes of less than three milliliters, electrode-driven heating can stabilize sample temperature within the electrolysis cycle duration under closed-loop thermistor control. Temperature compensation parameters may additionally account for seasonal ambient variation across deployment environments. Thermometers, pH, and other sensors 97, such as temperature, pressure, humidity, ambient light, nutrient detectors, and others, may reside in channel 58, or in other locations around the device to gather information about the analyte and the environment from which the analyte was sampled.

In some embodiments, the device may incorporate capacitive sensing or other electrode-based measurement modalities operating in parallel with the spectrometry subsystem. Capacitive sensing of the electrolyzed sample may provide an independent signal correlated with compound concentration, which the controller may combine with spectrometric measurements to improve detection accuracy or provide redundancy. Other parallel electrode methods, including voltammetric or amperometric sensing, may similarly be operated concurrently with spectrometric detection within the same fluid chamber or an adjacent chamber on the same fluid path. The use of multiple independent measurement modalities on a single sample is within the scope of the embodiments. FIG. 6 shows electrodes such as 108 arranged to analyze a sample in a separate path. The electrodes used for sensing may also reside in the pre-processing chamber 96, if used, or a post-processing chamber.

In some embodiments, additional sensors to track environmental or other external or internal characteristics can be added to the learned model to improve predictions of compound concentration in the sample. No limitation to any particular sensor type, sampling type, method, or implementation is intended. Examples of additional sensors contemplated by this disclosure include, without limitation, pH sensors, temperature sensors, pressure sensors, humidity sensors, ambient light sensors, sensors for other dissolved nutrients or analytes, and a location module or GPS receiver providing geolocation coordinates to be appended to the measurement records. Data from any one or more of these sensors may be provided as an input to the calibration and/or prediction model.

The device outputs many parameters. These may include the molarity of nitrogen in each of its compounds in the sample. The device may also communicate the molarities of other compounds if detected. The device may also provide an output indicating whether the sample is deficient, sufficient, or surplus, as specific molarities of each compound are known to be in each of these ranges. The device could also provide suggestions or recommendations as to what the user could do to solve any problems due to excess concentrations. All data may be recorded by and stored on the controller, which may include a memory, or elsewhere for later referencing.

In some embodiments, measurement records may be cryptographically signed by the device at the time of collection, producing a tamper-evident log suitable for regulatory compliance, discharge reporting, or chain-of-custody documentation. The signing key may be stored in secure hardware on the controller. Such signed records may be transmitted via wireless communication protocols including Bluetooth, cellular, or low-power wide-area protocols such as LoRa, which are particularly suited to remote agricultural deployments without reliable cellular coverage. Aggregated data from one or more devices may be collected by a centralized platform for longitudinal trend analysis across a facility or field site.

In some embodiments, the device may be configured in a form factor sized to fit within a groundwater monitoring well casing, including casings of two to four inches in diameter, enabling in-situ deployment for continuous subsurface nutrient monitoring without requiring sample extraction to the surface.

In some embodiments, a GPS receiver or location-determination module 98 may append geolocation coordinates to signed measurement records alongside timestamp and compound concentrations, supporting chain-of-custody documentation for discharge reporting and field-level nutrient balance calculations across distributed deployments. The controller may additionally compare measurement results against configurable regulatory threshold values and transmit automated alerts to a connected monitoring platform upon exceedance. In some embodiments, the location module may further include a depth sensor to record the depth of sample collection, for example when the device is deployed within a groundwater monitoring well or other submerged installation. Depth data may be appended to signed measurement records alongside geolocation coordinates, timestamp, and compound concentrations.

The discussion below provides an example of a more specific process for detecting traces of compounds. Processing the soil sample is very similar to making tea. First, a soil sample (1 g) should be taken and steeped in warm water (10 mL) at 30 to 50 degrees Celsius. The ratio of 1 g:10 mL is only the recommended ratio for mixing and dilution. Stir gently for 1 minute before straining into a beaker or other flask. This is the aqueous sample, used in the following instructions. Note that the process can also use liquid samples, such as from ground water or runoff. In some embodiments, the sample may be collected directly from existing soil pore water in situ using a suction-cup lysimeter, a porous probe connected to a vacuum source that draws pore water through the probe tip, rather than steeping a discrete soil sample in added water. In either case, this discussion here refers to them generally as “sample(s).”

Where a solid soil sample is used, the mass-to-volume ratio of the steeping step is recorded and applied as a scaling factor when converting device output to concentration per unit mass of original soil.

The device filters the sample before it enters the electrolysis chamber. By activating the electrolysis switch, the device then complete 5 minutes of single cell copper electrolysis. The outlet filter then filters the sample, and the channel mixes the sample before letting it exit the chamber.

As the sample is pulled into the electrolysis chamber, it may prove helpful if the user holds the device so that the sample is moving upward, the syringe/collector at the top, and the inlet at the bottom. After electrolysis, to prevent bubbles forming before the spectrometric detection, the user should turn the device 180 degrees, so the sample is pulled downward, syringe at the bottom, inlet at the top. Controlling the flow rate of the sample can prevent bubbles and allows completion of the entire process in a timely fashion.

In this embodiment, the device manages gas bubble formation to prevent optical artifacts in the spectrometry subsystem. During electrolysis, the device is oriented with the collector port upward so that evolved gas rises toward the collector rather than toward the channel outlet. After electrolysis completes, the device is inverted approximately 180 degrees, so the sample transfers downward through the outlet filter under gravity-assisted flow, allowing residual bubbles to migrate away from the outlet before spectrometric measurement. The controller samples each receiver at sufficient frequency to identify transient transmittance spikes consistent with bubble passage and discards flagged readings from the absorbance calculation. Where flagged readings exceed a configurable fraction of the measurement window, the controller aborts the measurement and prompts the user to repeat the sample draw. No limitation to any particular orientation protocol or rejection threshold is intended.

In the spectrometry chamber, an emitter and a receiver operate in pairs to read transmittance intensity at 520 nm (baseline), 615 nm (copper-ammonium-ion-complex), and 850 nm (copper (II) nitrate). According to the Beer-Lambert law, absorbance intensity is proportional to molarity, given a constant light path length and molar absorption coefficient. Since the latter two variables are constant, this equation can give us a mathematical model to convert the absorbance intensity at a given wavelength to the molarity of a compound in the sample.

In this device, the transmittance intensity is sampled, meaning the receiver measures the light from the emitter after passing through the sample. Absorbance intensity is the negative log of transmittance intensity, and so the transmittance intensity can convert to absorbance intensity.

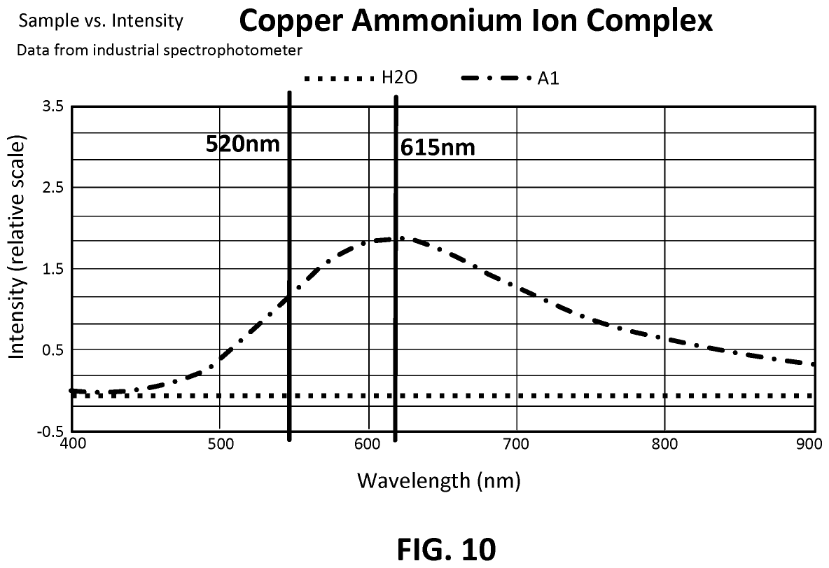

FIG. 10 shows a graph of a turbid copper-electrolyzed 2.57 M ammonium-hydroxide sample. Note the 615 nm visible spectrum range line, representing emitters and receiver detection wavelength, lies at the peak of the absorbance spectrum. The 520 nm visible spectrum range emitters and receiver are around the “baseline” of the spectrum, so the offset can be used as a relative, as opposed to absolute, measurement of the sample. This allows us to account for error in transmittance intensity which stems from sample turbidity. In FIG. 10, H₂O refers to a baseline sample of distilled water run through the process, and Al refers to 2.57M ammonium hydroxide run through the process.

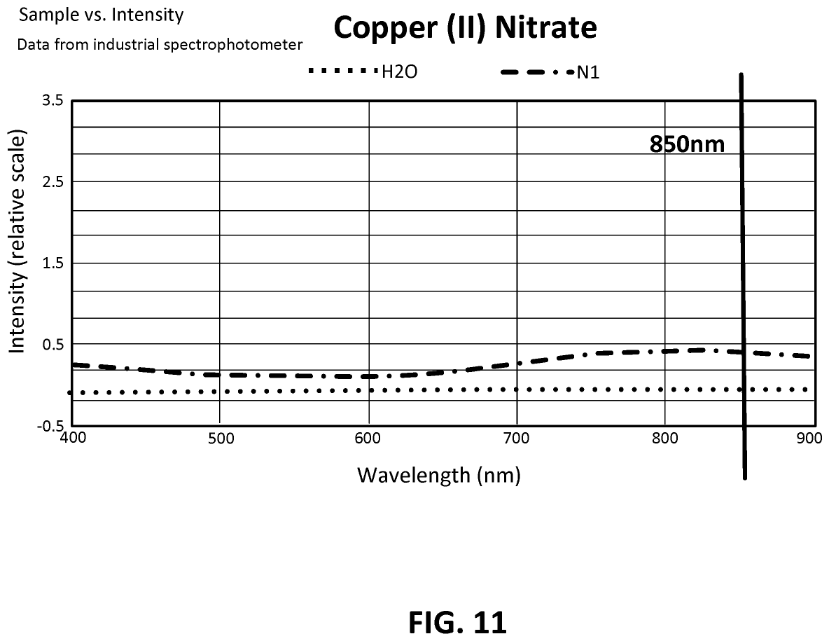

FIG. 11 shows a copper (II) nitrate graph, after copper-electrolysis of 1.0 M magnesium-nitrate, very similar to the one above, except the peak is at 850 nm, the IR spectrum range. The same 520 nm baseline is used for reference for nitrate detection as well. In FIG. 11, H₂O refers to a baseline sample of distilled water run through the process, and N1 refers to 1.0M magnesium nitrate run through the process.

The below equation provides an example of a calibration equation derived from the absorbance intensity values, after converting from transmittance intensity by taking the negative logarithm. The intensity is also measured on a relative scale, through voltage received after transmittance, from the receiver.

$$Molarity = \frac{Absorbance Intensity - B}{K}$$

$$Absorbance Intensity = {log}_{10} ( \frac{1}{Transmittance Intensity} ) = - {log}_{10} ( Transmittance Intensity )$$

The following is a sample calculation, which includes a data table, its data points, and the molarity to absorbance intensity conversion equation. The following example is specific for the 850 nm emitter-receiver pair, for nitrate detection, as there would be a separate emitter-receiver pair for the 615 nm ammonium detection.

| Molarity (M) | 0.0600 | 0.1300 | 0.2500 |
|---|---|---|---|
| Transmittance | 145 | 116 | 90 |
| Intensity | | | |
| Absorbance Intensity | −2.1614 | −2.0645 | −1.9542 |

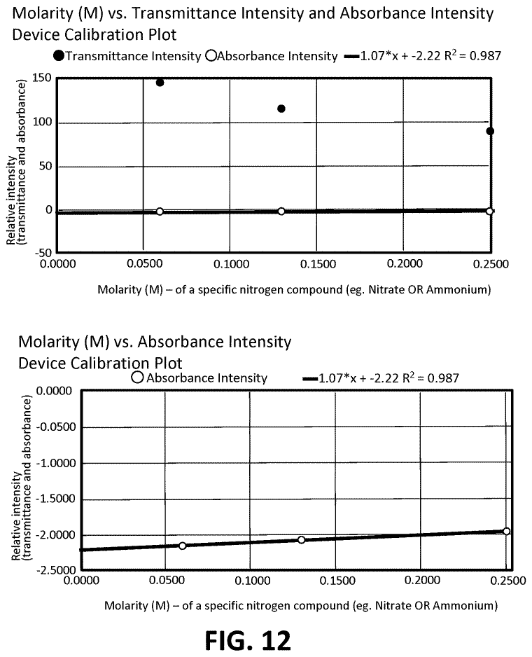

FIG. 12 shows a graph of this data and shows a relationship with 99.7% correlation between absorbance and molarity. In equation form this is:

$$Molarity = \frac{Absorbance Intensity + 2.22}{1.07}$$

Another calibration curve found using univariate regression for the copper-ammonium-ion-complex channel, evaluated across the 100-1000 ppm concentration range, demonstrates a 99.6% R² correlation between absorbance intensity at 615 nm and ammonium molarity. The nitrate channel similarly achieves 95.7% R² correlation across the same concentration range.

The following is a sample calculation, which includes a data table, its data points, and the molarity to absorbance intensity conversion equation.

### Nitrate Calibration: 850 nm Emitter-Receiver Pair (Baseline-Corrected at 520 nm)

| Molarity (M) | Absorbance Intensity (relative) | Std Dev |
|---|---|---|
| 1.000 | −0.020 | 0.270 |
| 0.500 | −0.601 | 0.030 |
| 0.250 | −0.678 | 0.080 |
| 0.125 | −0.674 | 0.030 |
| 0.063 | −0.812 | 0.030 |
| 0.050 | −0.881 | 0.030 |
| 0.031 | −1.235 | 0.190 |
| 0.016 | −1.623 | 0.180 |
| | −1.273 | 0.190 |

Data averaged across three independent trial sets. Absorbance intensity is the turbidity-corrected relative value obtained by subtracting the 520 nm baseline reading from the 850 nm channel reading prior to regression.

The nitrate calibration data exhibits two approximately linear regions. For the higher-concentration region (0.063M-0.5M):

Absorbance Intensity=Molarity×0.84−0.908, R²=0.953

For the lower-concentration region (0.016M-0.063M), relevant to drinking water and groundwater monitoring (2-70 ppm range):

Absorbance Intensity=Molarity×17.55−1.840, R²=0.950

Isolating for molarity in each region, because in application, one solves for Molarity using the absorbance intensity measurement:

Molarity (high range)=(Absorbance Intensity+0.908)/0.84

Molarity (low range)=(Absorbance Intensity+1.840)/17.55

The elevated standard deviation at 1.0M and 0.008M indicates reduced linearity at the extremes of the tested range, consistent with known limitations of Beer-Lambert linearity at very high and very low absorbances. The calibration model may be fitted independently over each linear subrange, or a multivariate regression incorporating all data points may be applied with appropriate weighting. No limitation to any particular concentration subrange or fitting method is intended.

### Ammonium Calibration: 615 nm Emitter-Receiver Pair (Baseline-Corrected at 520 nm)

| Molarity (M) | Absorbance Intensity (relative) | Std Dev |
|---|---|---|
| 1.290 | −0.370 | 0.132 |
| 0.645 | −0.735 | 0.134 |
| 0.323 | −0.977 | 0.007 |
| 0.161 | −1.065 | 0.014 |
| 0.081 | −1.101 | 0.030 |

Absorbance Intensity=Molarity×0.616−1.156, R²=0.996

Molarity=(Absorbance Intensity+1.156)/0.616

### Phosphate Calibration: 650 nm Emitter-Receiver Pair

| Molarity (M) | Absorbance Intensity (relative) | Std Dev |
|---|---|---|
| 0.500 | −0.356 | 0.130 |
| 0.250 | −0.978 | 0.000 |
| 0.125 | −1.262 | 0.130 |

Absorbance Intensity=Molarity×2.426−1.573, R²=0.999

Molarity (high range)=(Absorbance Intensity+1.573)/2.426

### Sulfate Calibration: 750 nm (Using a 570 nm Detector/700 nm Emitter)

| Molarity (M) | Absorbance Intensity (relative) | Std Dev |
|---|---|---|
| 0.500 | +0.301 | 0.000 |
| 0.250 | −0.370 | 0.090 |
| 0.125 | −0.544 | 0.000 |
| 0.063 | −0.778 | 0.000 |

Absorbance Intensity=Molarity×2.382−0.906, R²=0.987

Molarity (Absorbance Intensity+0.906)/2.382

Each calibration curve was derived using the turbidity-corrected relative absorbance method, subtracting the 520 nm baseline reading from the compound-specific channel reading prior to regression. A corresponding calibration curve for the copper-ammonium-ion-complex channel, evaluated across the 100-1000 ppm concentration range, demonstrates a 99.6% R² correlation between absorbance intensity at 615 nm and ammonium molarity. The nitrate channel similarly achieves 95.7% R² correlation across the same concentration range.

In some embodiments, the device may process samples containing multiple analytes simultaneously, including combinations of nitrate, phosphate, and sulfate in a single electrolyzed sample. Multivariate regression applied across all active wavelength channels simultaneously achieved greater than 96% prediction accuracy on lab-grade mixed samples of known molarity, compared to greater than 83% accuracy using independent linear regression per analyte. A neural network model trained on multi-channel absorbance data demonstrated improved prediction accuracy over linear regression (R²=0.968 vs R²=0.819 on nitrate in mixed samples), indicating that machine learning calibration models may be employed to improve simultaneous multi-analyte detection accuracy. No limitation to any particular multivariate regression, model architecture, or analyte combination is intended.

Organic samples collected from natural sources including river water, creek water, pond water, and soil were processed through the full electrolysis and spectrometry pipeline, and predicted molarities correlated directionally with results from qualitative powder indicator test strips, providing a field-level validation of the method against an easily commercially available reference.

In this manner, an inexpensive, simple device and method can achieve detection of trace compounds. Other known detection approaches for these compounds include potentiometric ion-selective electrodes, spectrophotometric/colorimetric assays, ion chromatography, capillary electrophoresis, and solid-state ion-sensitive field-effect transistors (ISFETs). Electrode-based approaches, such as ion-selective electrodes, often use electrodes made of special carbon-based compounds to reduce frequency of electrode replacement. The method of the embodiments sacrifices its electrodes in exchange for being more easily accessible, in contrast with the approaches that use the expensive carbon-based electrodes.

In some embodiments, the device may monitor and/or manage electrode degradation and white precipitate accumulation that occurs during single-cell electrolysis as electrode material transfers between anode and cathode. Left unaddressed, precipitate buildup can affect reaction consistency and interfere with downstream spectrometric readings. The device may address this through one or more of the following: a brief reverse-polarity conditioning pulse applied to the electrodes prior to sample introduction; periodic polarity reversal during electrolysis to redistribute accumulation across both surfaces; a post-measurement rinse cycle to flush precipitate before spectrometric analysis; or single-use replaceable electrode inserts such that buildup does not carry across successive samples. The controller would notify a user that the insert needs to be replaced. In deployments requiring extended operational lifetime, the electrode insert and associated consumables may be designed for a minimum number of measurement cycles before replacement and/or automatic electrode replacement supporting continuous field deployment over periods of weeks to months without manual intervention. The outlet filter downstream of the electrolysis chamber may additionally capture dislodged particles before the sample reaches the spectrometry subsystem. No limitation to any particular precipitate management approach is intended.

In some embodiments, the electrode insert may incorporate a self-cleaning mechanism to remove precipitate accumulation without requiring manual intervention or electrode replacement between every measurement. The cleaning cycle is triggered automatically before, during, or after each sample completes electrolysis and before the next sample enters the electrolysis chamber, ensuring each sample is exposed to a fresh electrode surface. In one embodiment, the electrode is configured to move axially through a close-fitting annular wiper ring fabricated from a chemically inert, low-friction material such as polytetrafluoroethylene (PTFE). Reciprocating axial motion of the electrode through the wiper ring mechanically removes surface precipitate around the full electrode circumference with each cleaning cycle. The wiper ring geometry may include ridged or textured interior surfaces to increase scraping effectiveness. Axial motion may be driven by a small motor or piezoelectric actuator under controller direction, triggered automatically between measurement cycles or upon detection of elevated baseline readings indicative of precipitate accumulation. FIG. 9 shows an embodiment of an annular wipe ring.

A replaceable cartridge containing liquids and reagents of known molarities may be provided. The cartridge can connect to both electrodes and wiper mechanisms. The device may incorporate a separate calibration standard cartridge containing sealed reservoirs of solution at known compound concentrations. The controller may autonomously or be instructed to draw from this cartridge at scheduled intervals or upon detection of measurement drift, running the standard through the full measurement pipeline to update calibration parameters with or without user intervention or lab return. The calibration and electrode cartridges may be replaced independently. No limitation to any particular cartridge configuration or recalibration trigger is intended.

In some embodiments, the controller triggers a recalibration process upon one or more of: detection of electrode degradation or reduced signal consistency across successive measurement cycles; replacement of an electrode insert or other consumable component; or a decline in battery charge sufficient to alter the intensity or consistency of light output from the one or more emitter-receiver pairs. Recalibration triggered by battery-level changes may include adjusting reference baseline readings or reapplying stored calibration curves to compensate for reduced or variable emitter output. No limitation to any particular recalibration trigger or combination of triggers is intended.

Currently deployed devices using spectrometry to measure sample concentrations incur higher costs of detection up because emitting and detecting of wavelengths in the non-visible ranges (UV and IR) have much higher costs. The scarcity of supplies to carry out these readings makes these currently existing processes inaccessible where needed. By combining multiple concepts into one process, the aforementioned problems are solved.

Unlike prior approaches in which electrolysis and optical measurement occur within a single undivided cell on an unmodified sample, the present device applies electrolysis as a chemical preprocessing step that transforms the sample into uniform electrode-compound complexes before transferring it through an integrated conditioning channel to a physically separate spectrometry chamber for bulk optical measurement.

Variations and modification exist. While the current embodiments address the use of electrolysis prior to spectrometry, other electrode-based concentration detection options could be used with spectrometry. These may include voltametric or amperometric systems. While the electrical enclosure here is referred to as an electrolysis chamber, it may be employed in a voltametric, amperometric or potentiometry system with little or no modification of the main components. These types of systems are considered to be within the scope of the claims and encompassed by the use of the term “electrolysis chamber.” The device may also perform other measurements such as pH and temperature by inclusion of a pH meter and a thermometer. Further, the electrolysis chamber may also be referred to as an electrolysis subsystem, and the spectrometry chamber may also be referred to as a spectrometry subsystem.

In some embodiments, the device may implement standard integration protocols including Modbus, MQTT, OPC-UA, and REST-based APIs to interoperate with existing SCADA, LIMS, and agricultural management platforms without proprietary integration. The device is not limited to any particular protocol suite; any communication protocol required by the deployment environment, end-user specification, or regulatory framework is within the scope of the embodiments.

An embodiment comprises a calibration method employing multivariate regression incorporating measurements across all active wavelength channels simultaneously.

An embodiment comprises a calibration method including cross-compound interaction terms to account for spectral overlap between compounds and sample turbidity.

An embodiment comprises a method of deriving a quantitative turbidity estimate from differential transmittance between a reference wavelength channel outside target compound absorption bands and one or more compound-detection channels.

An embodiment comprises a method of operating the device wherein a subsequent sample enters the electrolysis subsystem while a prior sample is simultaneously undergoing spectrometric analysis.

An embodiment comprises a method wherein multiple samples from different sources are processed in sequence with reduced total throughput time via subsystem pipelining.

An embodiment comprises a method wherein a single sample is split across multiple electrolysis chambers, with results averaged or compared to identify and reject outliers caused by electrode fouling or colloidal interference.

An embodiment comprises method of combining signals from multiple independent measurement modalities to determine compound concentration from a single sample.

An embodiment comprises a method of generating tamper-evident measurement logs suitable for regulatory compliance or chain-of-custody documentation.

An embodiment comprises a method of preparing a solid soil sample by steeping in water at a defined mass-to-volume ratio, wherein that ratio is recorded and applied as a scaling factor when converting device output to concentration per unit mass of original soil.

An embodiment comprises a method of operating the device wherein the collector port is oriented upward during electrolysis so that evolved gas rises away from the channel outlet.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific embodiments have been illustrated and described for purposes of illustration, it will be understood that various modifications may be made without departing from the spirit and scope of the disclosure. Accordingly, the invention should not be limited except as by the appended claims.

1. A detection device, comprising:
a collector having one or more inlets to allow collection of one or more samples;
one or more electrolysis subsystems, each electrolysis subsystem including at least two electrodes positioned in the electrolysis subsystem to contact at least one sample, the electrolysis subsystem connected to the one or more inlets to receive the at least one sample and apply electrolysis to the at least one sample to prepare the at least one sample for spectrometry by separating a sample solution into one or more compounds and increase uniformity of the sample;
one or more spectrometry subsystems, each spectrometry subsystem connected to the one or more electrolysis subsystems by a channel, each spectroscopy subsystem including:
one or more emitters; and
one or more receivers, each receiver corresponding to an emitter of the one or more emitters; and
a controller configured to activate the one or more emitters and receive at least one signal from the one or more receivers and to provide a measurement of the one or more compounds;
a communication port in communication with the controller to transmit data to allow display of the measurement; and
a power supply electrically connected to at least the electrodes, the emitters, the receivers, the controller, and the display.

2. The detection device as claimed in claim 1, wherein the controller is configured to operate the one or more electrolysis subsystems at staggered time intervals to provide a pipeline of samples for the spectrometry subsystem.

3. The detection device as claimed in claim 1, wherein the channel includes internal surface features to cause passive mixing of an electrolyzed sample prior to entering the one more spectrometry subsystems.

4. The detection device as claimed in claim 1, wherein the channel is configured to move the sample from the electrolysis subsystem to the spectrometry subsystem either without a pumping force, or with an automated pumping under controller direction without manual actuation.

5. The detection device as claimed in claim 1, wherein the at least two electrodes comprise low-reactivity conductive materials.

6. The detection device as claimed in claim 1, wherein one or more of the at least two electrodes reside in a replaceable electrode insert, the electrode insert including a cleaning mechanism to clean one or more of the electrodes and the electrolysis chamber.

7. The detection device as claimed in claim 1, wherein the controller is configured to one or more of perform a recalibration process when an electrode insert replacement occurs, monitor electrode degradation, and correct electrode degradation.

8. The detection device as claimed in claim 1, further comprising a closed-loop thermistor to monitor a temperature of the sample and the controller controls the at least two electrodes to resistively heat the sample to a target temperature.

9. The detection device as claimed in claim 1, wherein the one or more emitters and corresponding receivers comprise emitter-receiver pairs of wavelengths determined by absorption characteristics of electrode-compound complexes produced during electrolysis.

10. The detection device as claimed in claim 1, wherein the controller is configured to illuminate the one or more samples by one of either:
firing all emitters simultaneously based upon one of either a number of analytes or available hardware, and wherein each receiver is optically isolated such that each receiver only detects wavelengths for that receiver; or
firing all emitters sequentially based upon one of either a number of analytes or available hardware, and to read each receiver in turn.

11. The detection device as claimed in claim 1, wherein the spectrometry subsystem includes one or more of bandpass optical filters, interference optical filters, and a diffraction grating to disperse transmitted light across a photodetector to capture spectral data.

12. The detection device as claimed in claim 1, wherein the spectrometry subsystem includes one or more electrodes, and the controller is configured to use one or more electrodes to perform one or more of capacitive sensing, voltametric sensing, and amperometry sensing of the one or more samples in addition to spectrometry.

13. The detection device as claimed in claim 12, wherein the controller is configured to execute a model to one or more of calibrate the detection device and make predictions, the model configured to update based upon accumulated field measurements, and is further configured to:
incorporate accumulated site-specific measurement history; and
build a location-adaptive baseline that is updatable with new data.

14. The detection device as claimed in claim 13, further comprising additional sensors, and data from the additional sensors are input to the model.

15. The detection device as claimed in claim 13, wherein the controller is configured to compute turbidity and use the turbidity as one or more of a correction factor in the model, and a standalone output and provided with the measurement.

16. The detection device as claimed in claim 1, further comprising a sensor between the one or more inlets and the one or more electrolysis subsystems, and the controller is configured to receive a pH reading from the pH sensor and use the pH reading as a correction variable in the model.

17. The detection device as claimed in claim 1, wherein the controller is configured to execute a model to convert sensor and manual inputs to output molarities per analyte.

18. The detection device as claimed in claim 1, wherein the power supply comprises a battery, an alternative current source, or a direct current source.

19. The detection device as claimed in claim 18, wherein the power supply comprises a battery and the controller is configured to manage battery power by one or more of:
reducing measurement frequency when battery level falls below a configurable threshold;
powering down inactive subsystems between measurement cycles;
managing battery power by a pre-set configuration;
dynamically adjusting settings; and
deferring or batching wireless transmission consumption.

20. The device as claimed in claim 1, wherein the controller is configured to monitor behavior patterns at sufficient frequency to detect and dispose of anomalous readings.

21. The device as claimed in claim 20, wherein the controller aborts measurements and triggers a repeated sample draw when flagged readings exceed a configurable fraction of a measurement.

22. The device as claimed in claim 1, wherein each measurement forms a measurement record, and each measurement record is cryptographically signed to create a signed measurement at a time of collection using a key stored in secure hardware on the controller and the device transmits the signed measurement in accordance with one or more communication protocols, wherein the communication protocol used depends upon a deployment environment, and in accordance with one or more integration protocols, wherein the integration protocol used depends upon the deployment environment, an end-user specification, and or a regulatory framework.

23. The device as claimed in claim 1, further comprising one of either a location module, a depth sensor, or a Global Positioning System receiver that appends geolocation coordinates to measurement records, the controller configured to generate automated alerts upon exceedance of configurable regulatory thresholds.

24. The device as claimed in claim 1, wherein the collector accepts liquid samples directly or aqueous extracts prepared from solid samples.

25. The device as claimed in claim 1, wherein the electrolysis and spectrometry subsystems reside on a microfluidic chip.
